(19) United States
(12) Patent Application Publication
(10) Pub. No.: US 2013/0110660 A1
(43) Pub. Date: May 2, 2013

(54) METHOD OF COLLECTING OPINIONS AND SURVEYING DATA

(71) Applicants: BILLSON YANG, NEW TAIPEI CITY (TW); SHAN-HO YANG, NEW TAIPEI CITY (TW); TUNG-YU YANG, NEW TAIPEI CITY (TW)

(72) Inventors: BILLSON YANG, NEW TAIPEI CITY (TW); SHAN-HO YANG, NEW TAIPEI CITY (TW); TUNG-YU YANG, NEW TAIPEI CITY (TW)

(21) Appl. No.: 13/282,793

(22) Filed: Oct. 27, 2011

(51) Int. Cl. G06F 17/00; G06Q 20/22; G06Q 30/06; G06F 15/16

(52) U.S. Cl. 705/26.1; 715/760; 705/35

(57) ABSTRACT

A method of collecting opinions and surveying data is provided, including the steps of: step A, an asker raises an opinion; step B, the contents of the opinion is filtered by a keyword filter of a system website to determine whether the opinion can be posted in the system website and notify the asker; step C, a user browses the system website to select an opinion, respond to the opinion, and participate in voting opinion; and step D, a compiler of the system website collects and integrates the responded opinions and voted opinions from step C into survey data that is stored in a database of the system website to allow the system owner to effectively collect and integrate the opinions for further applications.

### FIELD OF THE INVENTION

The present invention generally relates to a method of collecting opinions and surveying data, and more specifically to collecting public opinions and survey of opinions through website for statistics and analysis.

### BACKGROUND OF THE INVENTION

In general, social network services (SNS) websites provides an online discussion process in the format of forum (such as discussion forum, bulletin board) on the website to allow the community or non-community members to participate in discussing various topics so that everybody can have their say on networks.

However, the above website forum format often shows problems, some being briefed below:

(1) Currently, websites do not provide a function or service of surveying public opinion when a question is raised. If a person wishes to obtain public opinion, the person must present a question and observes what the others respond to the question. However, as the responses are usually from a handful of active others, the so-called public opinion may be easily used by the opportunists to suit specific purpose, instead of the actual public opinion.

Because website forums usually have many articles or posts with similar topics and they are often scattered around various website forums. If a website administrator does not organize, filter, or merge these posts regularly, the readers of the forums may be easily confused by scattered and yet overlapping information, not to mention the extra space in the website database. Even if the administrator does provide a frequently asked question (FAQ), the contents of the FAQ may still be easily affected by the administrator's bias or personal choice, instead of objective public opinions.

(3) In website forums, there may be many cross-talks when a dispute arises. If a vote is conducted to settle the dispute, the voting result is also often subject to skepticism. In addition, the administrator usually can neither summarize and integrate these opinions effectively nor tracking these questions. Therefore, the records of events may simply be deleted after a period of time and the same dispute may arise again in the future.

Thus, the present invention aims to provide a method of collecting opinions and surveying data, which can collect opinions and survey public opinions at the same time.

### SUMMARY OF THE INVENTION

A primary objective of the present invention is to provide a method of collecting opinions and surveying data, in which by means of a unique device of sub-question, public opinions can be summarized fast to avoid being trapped in dispute and to complement the basic data of the users.

Another objective of the present invention is to provide a method of collecting opinions and surveying data, in which by means of various mechanisms, including a group voting mechanism, a surrogate voting mechanism, and an audit mechanism, public opinion can be effectively summarized and analysis of the trend of the public can be done objectively.

Yet another object of the present invention is to provide a method of collecting opinions and surveying data, in which a payment mechanism is included to raise the value of each opinion.

To achieve the above objectives, the present invention provides a method that comprises the following steps: step A, in which an asker raises an opinion; step B, in which the contents of the opinion is filtered by a system website keyword filter to determine whether the opinion can be posted in the system website and notify the asker; and if so, the opinion is posted to the system website; otherwise, the system website notifies the asker to modify the statement and contents of the opinion; step C, in which a user browses the website to select an opinion, respond to the opinion, and participate in voting opinion; and step D, in which according to the responded opinions and voted opinions from step C, a compiler collects and integrates into survey data for storing in a database of the system website so that the system owner may effectively collect the opinions for further applications.

### BRIEF DESCRIPTION OF THE DRAWINGS

The present invention will be apparent to those skilled in the art by reading the following description of a preferred embodiment thereof with reference to the drawings, in which:

FIG. 1 shows a flowchart for a method of collecting opinions and surveying data according to the present invention;

FIG. 2 shows a schematic view of relation among an asker, a responder, a voter, and a system website according to the present invention;

FIG. 3 shows a schematic view of relation among the system website, a terminal user, an authentication center, a credit card issue bank, a credit processing bank, and a payment transfer station according to the present invention;

FIG. 4 shows a flowchart of group vote mechanism and surrogate vote mechanism according to the present invention;

FIG. 5 shows a schematic view of relation among the system website, a voting group, a voting representative and represented according to the present invention; and

FIG. 6 shows a schematic view of relation of the system website through a network with a desktop computer, a TV game machine, an Internet phone, a home telephone, a cell phone, a smart phone, a notebook computer, and a tablet computer according to the present invention.

### DETAILED DESCRIPTION OF THE PREFERRED EMBODIMENT

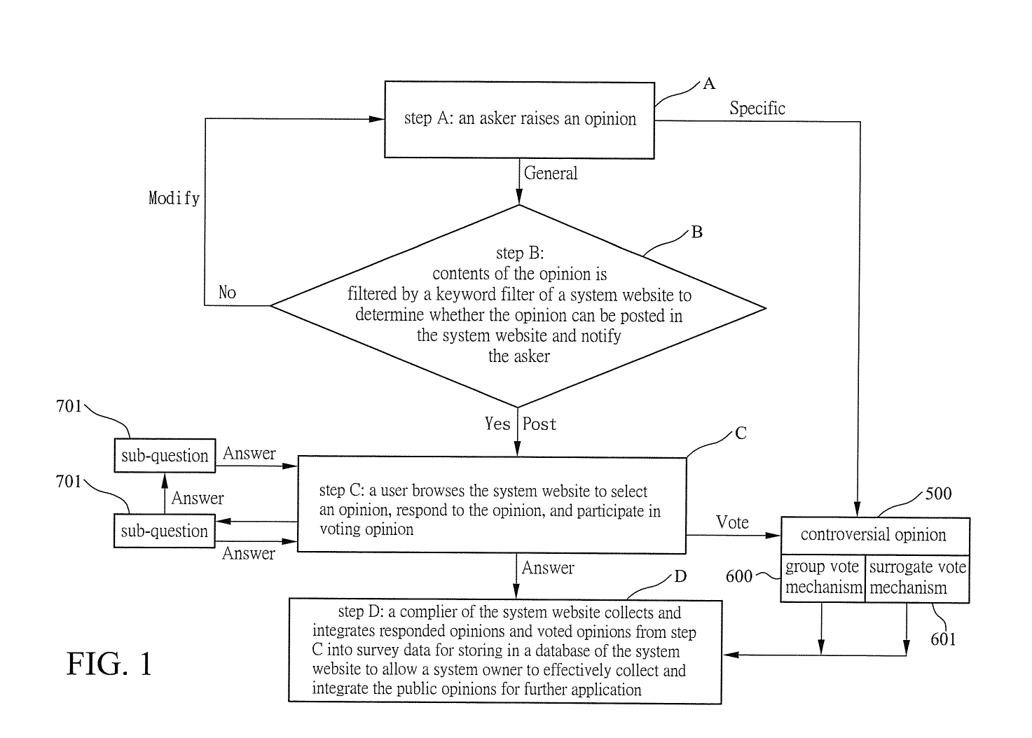

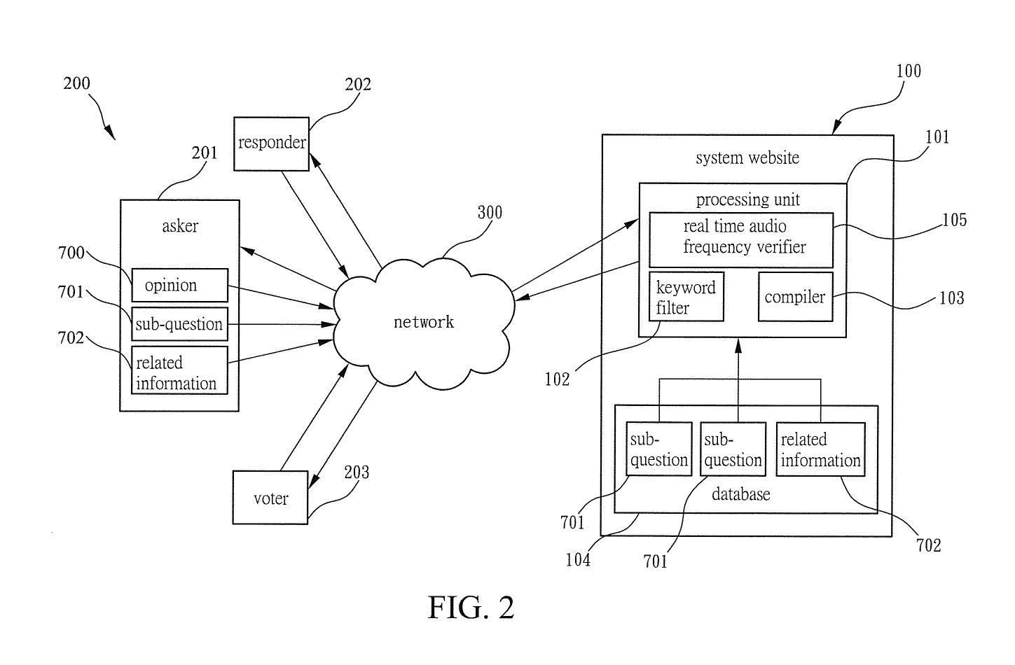

With reference to the drawings and in particular to FIGS. 1 and 2, the present invention provides a method for collecting opinions and surveying data. A website owner can set up a system website 100 as a platform. The system website 100 provides functions of social network services and online discussion so that any user 200 can login the system website 100 via network 300 to become a member for raising an opinion in the system website 100 (including raising an opinion, responding to an opinion, and voting an opinion). Every member is registered as a real name and identification and can cast one vote to any dispute or controversial opinions for the purposes of preventing faking events and potential internet crimes. The term “user” used previously may include an asker, a responder, a voter, and an opinion buyer. The system website 100 is hosted in a server and comprises a processing unit 101 and a database 104 linked to the processing unit 101. The processing unit 101 further comprises a keyword filter 102 and a compiler 103 connected to the network 300 and the database 104. Also, in the present invention, any content posted by a user in the system website is an opinion 700, and the content may include a question and any view.

The steps of the method according to the present invention are described as follows:

Step A: An asker raises an opinion 700. Every opinion is accompanied with related information, which is provided by users. The related information so provided can be those selected from news, commentaries, papers, books, or other websites (such as websites of bloggers, Wikipedia, and so on). The related information can be presented in the form of text, graphs, photo, or audiovisual file;

Step B: The contents of the opinion is filtered by the keyword filter of the system website to determine whether the opinion can be posted in the system website and notify the asker; and if so, the opinion is posted in the system website; otherwise, the system website notifies the asker to modify the contents of the opinion; in the present embodiment, negative keywords are used as filtering criteria;

Step C: A user browses the system website to select an opinion, respond to the opinion, and participate in voting opinion; and

Step D: The system website applies the compiler to collect and integrate the responded opinions and voted opinions from Step C into survey data (including background information and statistic numbers), which is stored in a database of the system website to allow the system owner to collect the opinions for further applications (such as, selling to asker or buyer).

In the above steps, every opinion 700 is accompanied by a plurality of corresponding sub-questions 701. These sub-questions can be generated by being established through the asker raising a question, or previously established in the database in advance by the system website. All the sub-questions are collected and summarized by the complier to form links indicating the correspondence relation, so that during a user expressing an opinion, a plurality of sub-questions can be popped up in a dialog box in a random manner or in a paired manner to force the users to answer the sub-questions before responding to the selected opinion so as to assist the system website to conduct opinion survey. However, the timing for sub-questions 701 to pop up is not limited to the aforementioned embodiment. The sub-questions can appear before or after the asker modifies the contents of the opinion so as to distribute the sub-questions among different steps to collect public opinions from all kinds of users and increase the interaction between the users and the system website. Through the derived sub-questions, the users are encouraged to respond and provide more detailed data, and even complement the membership information of the user so that the website owner can collect and integrate the opinions fast and apply more efficiently.

After every opinion is responded, if any user considers the responding opinion has insufficient contents or does not agree with the responding opinion, besides requesting for a vote, the user may raise a modified opinion by referring to the contents of the original opinion and to repeat the above steps, or respond with a new opinion. Therefore, in the present invention, a single opinion may be of different contents and responses, which are collected and integrated by the compiler to form an in-depth opinion and to divide the collected opinions into different types, including positive correlation, negative correlation, being neutral, and being innovative.

These opinions and sub-questions can be of different forms through programming, such as single issue questions, true-false questions, either-or questions, multiple choice questions, multiple choice questions with multiple answers, random questions accompanied by derived questions, linked questions, ranked questions, long term questions, questions with expiration date, whereby the asker can construct a question fast and easily, and the database is allowed to do statistics.

In searching and browsing opinions, when contents of an opinion is close to contents of another opinion, either the system website or the user can inform the website administrator for manual processing. Alternatively, the system website can automatically compare (for example, based on the popularity index of two opinions) and process, or open a public voting process with a limited period of voting time. The aforementioned processing includes merging, deleting, or other integration.

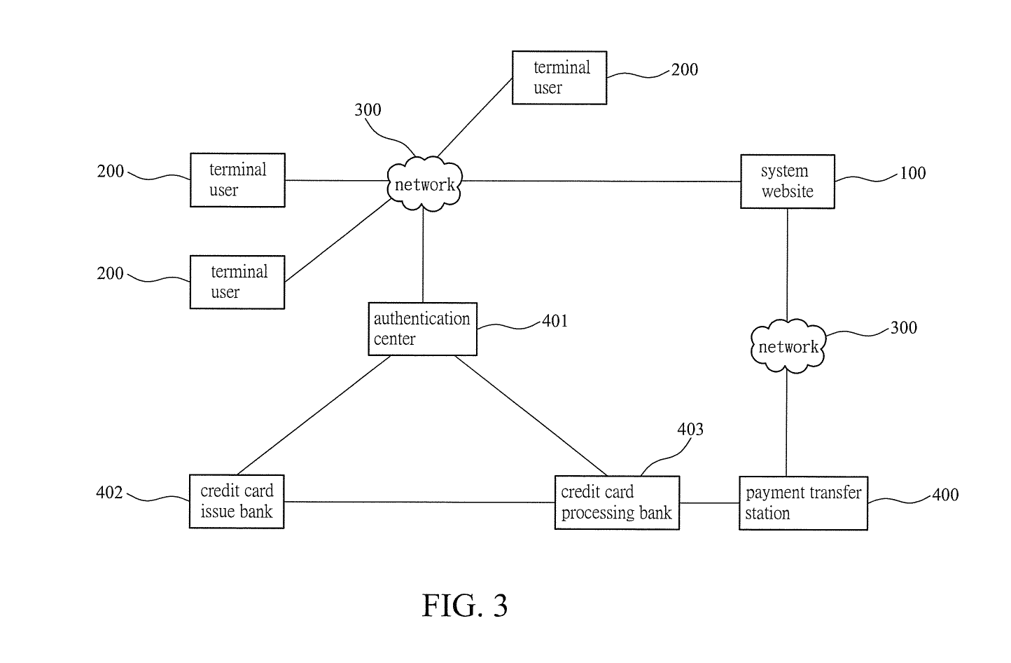

To increase the value of every opinion, the system website according to the present invention may further be provided with a payment mechanism, which, base on the contents, survey data and response level of every opinion, sets different price levels, with each price level corresponding to a view rights level. The view rights include the number of users to view, the number of times to view, the areas to view, the targets to view and the time to view. The response level depends on either the number of views that the opinion is searched, or the price bidding competition of the opinion. The payment mechanism allows internet electronic transaction (such as credit card). As shown in FIG. 3, between a user 200 at a terminal of a network and the system website 100, an internet electronic transaction can be done through facilities including an authentication center 401, a credit card issue bank 402, a credit card processing bank 403, and a payment transfer station 400.

When an asker requests to raise a specific opinion (such as a controversial opinion) for surveying data, to obtain the view rights level corresponding to the survey data (namely the statistic results of the survey and the survey data analysis), and to set authorized view conditions, the system website must examine the request. If the examination result is a fee must be paid, the request can be only carried out after the payment from the asker is done. The aforementioned setting authorized view conditions includes only for the asker to view, only for the authorized to view, agree to go public by the system website for public viewing, specific opinion only available for viewing with corporate business commercial, or specific opinion available for public viewing after a long period time (such as a program rating analysis).

As to view rights, the responders and voters of every opinion can only have limited view on the survey data of the opinion (such as other responses to the opinion), and other users, with an intention to view the opinion, must pay to acquire a corresponding view rights level. Any user can buy, through paying price set by the system website or through bidding, the view rights on responses and survey data of selected opinion. Also, the view rights can further be authorized to others after the user buys the view rights.

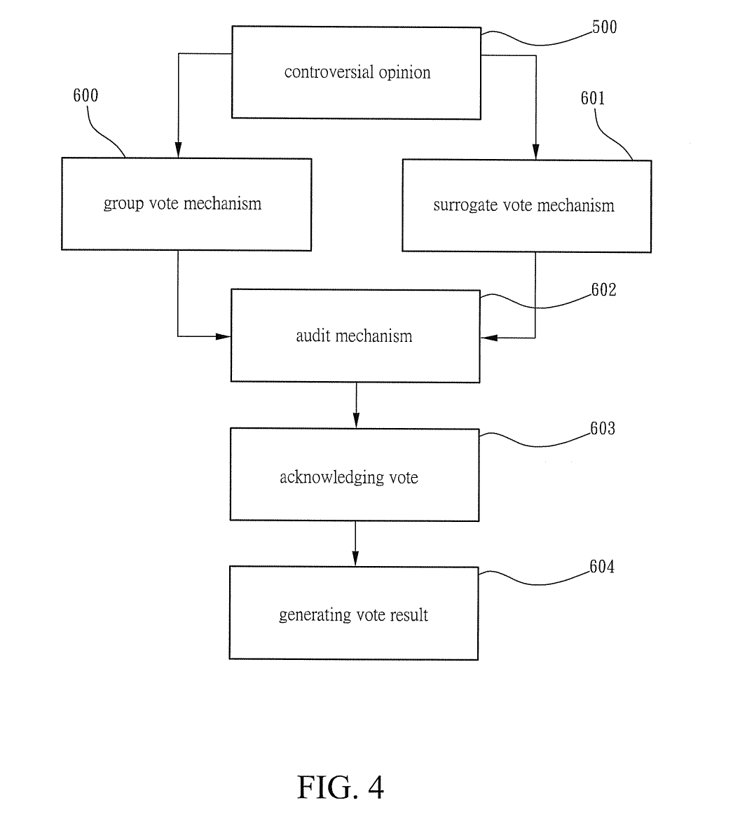

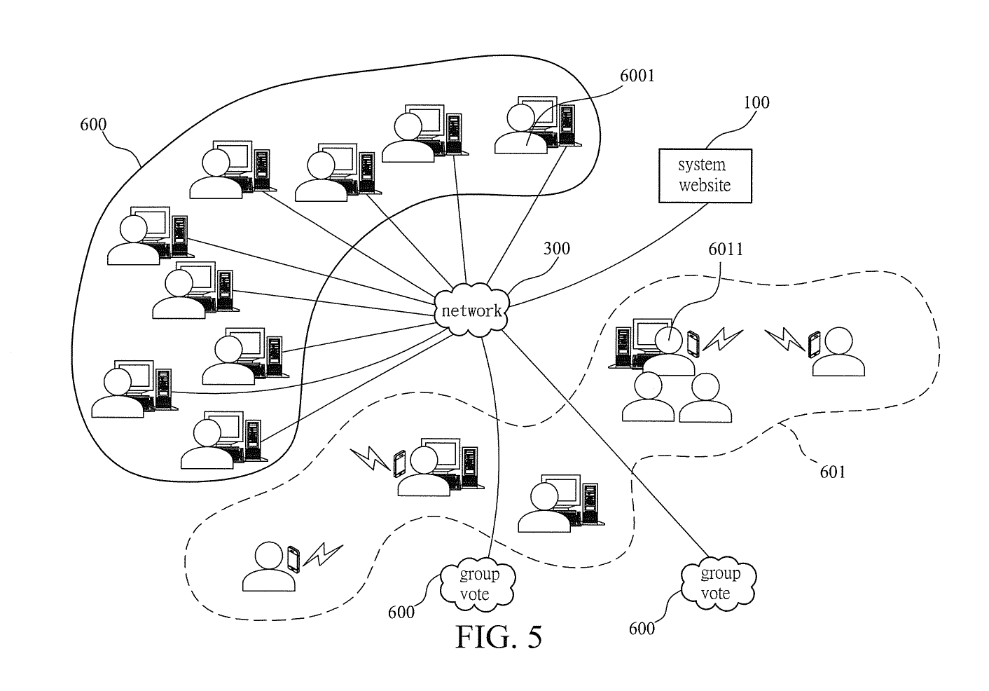

To accommodate more public opinions and avoid dispute, when a controversial opinion 500 occurs, as shown in FIGS. 4 and 5, the system website comprises a group vote mechanism 600, in which a voting group that is constructed by including an odd number of at least three members (the purpose of being odd number being to avoid a tie) can proceed with a vote on any opinion presented in the system website. Each voting group has a group leader 6001 selected from the group. If the group is unanimous, the group leader acts as a representative to vote for the group and provides the group member identity for auditing. The asker of the opinion can set the qualifications for the group composition, such as, number of members, demographic, age, and attributes.

For example, when an asker raises an opinion, the asker can set the number of members in the voting group. The number of members in a group is preferably a number that is not greater than nine (including the group leader). To proceed with voting within the group, the group leader and the remaining eight group members must use actual identities, accompanied with identification numbers, for auditing to avoid repeated voting. The number of the members in a group can be increased or decreased.

Secondly, because the asker may raise an opinion for specific purpose (such as TV program rating and approval rating for candidate in an election campaign), the asker may have specific demands on the demographics, ages, and attributes of the members of a voting group. For example, if the asker wants to know the opinions of Internet users aged between 16 and 35, then the voting group must have all the members aged between 16 and 35. A group leader that meets the qualification requirement must find his or her qualified members. On the other hand, group leaders or group members not qualified cannot vote for this opinion.

For voting for an opinion, all the actual names of the voting group members are listed. If any member does not agree with the group, with a mutual consent, the disagreed member may quit the voting group and make a vote independently. In the group vote mechanism, the number of votes in every voting group is limited, and a group leader cannot act as the group leader of another group. The present invention is not limited to the embodiment of using such a voting group and also allows a plurality of voting groups to consolidate and form a medium-size voting group and a plurality of such medium-size voting group to consolidate and form a mega voting group.

Furthermore, as shown in FIGS. 4 and 5, the system website also includes a surrogate vote mechanism 601 for people who do not know how to use internet or physically or mentally challenged, in which a member can obtain approval from others and acquires their identification numbers so that the member can become a surrogate 6011 to represent the others to vote on any opinion on the system website 100. In the surrogate vote mechanism 601, the number of votes that every member with surrogate qualification can represent is not limited. For those who cannot use internet, telephone contact can be used to prevent restriction on age group and demographics as well as shortening voting time to achieve fast voting decision. When the aforementioned voting group cannot reach unanimous opinion and the voting group is not applicable, the surrogate vote mechanism can be used as a replacement. Hence, in the present invention, all voting on the opinion can be realized through personal surrogate vote mechanism or group vote mechanism, or both.

As shown in FIG. 4, the system website 100 further comprises an audit mechanism 502, which can perform auditing through a represented user claiming a gift in person, a represented user using a gift in person, or obtaining the audio frequency of the represented user to re-confirm the representative and the represented are both members and the representation relation exists, and also audits if other group members or represented users have unanimous opinion. The aforementioned gift may include a present, equivalent points, and coupons. The aforementioned audio frequency can be verified by a real time audio frequency verifier 105 (see FIG. 2). Therefore, the audio frequency of the represented user can be verified through phone conversation. When the real time audio frequency verifier 105 of the system website detects the same audio frequency, the audit mechanism 502 is passed, and the subsequent step is for the system website to acknowledge the vote 503, followed by the step to wait for vote result 504.

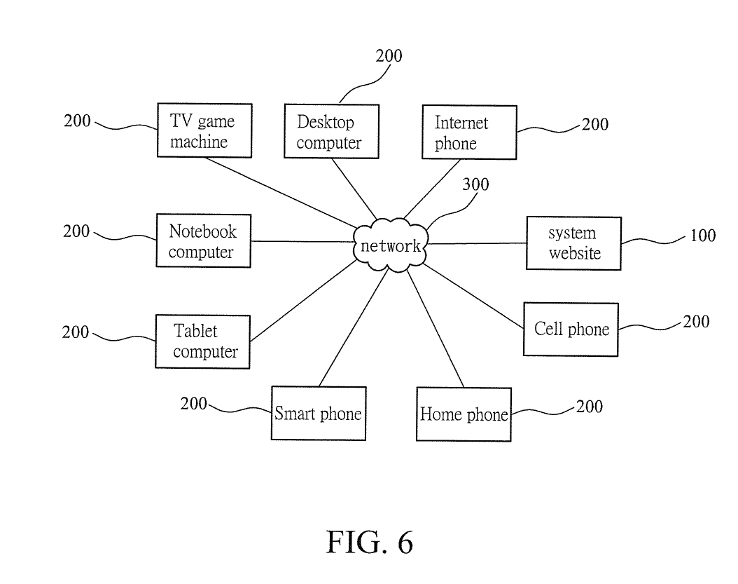

As shown in FIG. 6, logging in the system website can be made through one of a fixed device and a mobile device. A fixed device may be a desktop computer, a TV game machine, an internet telephone, a home telephone, and the likes. A mobile device can be a cell phone, a smart phone, a notebook computer, a tablet computer and the likes and is not limited to such devices.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A method of collecting opinions and surveying data, characterized in that a website owner sets up a system website to provide functions of social network services and online discussion so that any user is allowed to log in the system website via network to become a member for expressing an opinion with real name and identity in the system website, the user including an asker, a responder, a voter, and an opinion buyer, the method comprising the following steps:
step A: an asker raises an opinion;
step B: contents of the opinion is filtered by a keyword filter of the system website to determine whether the opinion is allowed to be posted in the system website and notify the asker; and if so, the opinion is posted to the system website; otherwise, the system website notifies the asker to modify the contents of the opinion;
step C: a user browses the system website to select an opinion, respond to the opinion, and participate in voting opinion; and
step D: a compiler of the system website collects and integrates responded opinions and voted opinions from step C into survey data for storing in a database of the system website to allow the system owner to effectively collect and integrate these opinions for further applications.

2. The method as claimed in claim 1, wherein every opinion is accompanied by related information and a plurality of corresponding sub-questions, the related information being provided by users, the sub-questions being generated when the asker raises a question, or pre-generated and pre-stored in a database by the system website, all the sub-questions being collected and summarized by the complier to form links indicating correspondence relation, whereby during an user expressing an opinion, a plurality of sub-questions is popped up in a dialog box in a random or paired manner to force the user to answer the sub-questions before responding to a selected opinion to help the system website conducting opinion survey.

3. The method as claimed in claim 2, wherein the opinions and sub-questions are of different forms through programming and are selectively one of the following forms: single issue questions, true-false questions, either-or questions, multiple choice questions, multiple choice questions with multiple answers, random questions accompanied by derived questions, linked questions, ranked questions, long term questions, questions with expiration date.

4. The method as claimed in claim 1, wherein when contents of an opinion is close to contents of another opinion, either the system website or the user is allowed to inform the system website for one of the following three processing options: the system website automatically comparison and processing, an website administrator for manual processing, and through public voting to process.

5. The method as claimed in claim 1, wherein the system website comprises a payment mechanism, whereby based on contents, survey data and response level of every opinion, the system website sets different price levels, with each price level corresponding to a view rights level, which includes number of users to view, number of times to view, areas to view, and targets to view and time to view, the response level being dependent on one of the following two options: number of views that the opinion is searched, or price bidding competition of the opinion.

6. The method as claimed in claim 5, wherein when an asker requests to raise a specific opinion for surveying data, to obtain a view rights level corresponding to said survey data, and to set authorized view conditions, the system website must examine the request, and if examination result is a fee must be paid, the request can be only carried out after payment from the asker is done, the setting authorized view conditions including one of the following: only for asker to view, only for authorized to view, agree to go public by website for public viewing, specific opinion only available for viewing with corporate business commercial, or specific opinion available for public viewing after a long period time.

7. The method as claimed in claim 6, wherein responders and voters of every opinion can only have limited view on the survey data of the opinion, and other users must pay to have corresponding view rights level to view the opinion, a user being allowed to buy, through paying price set by the system website or through bidding, the view rights on responses and survey data of selected opinion, the view rights being selectively authorized to others after the user buys the view rights.

8. The method as claimed in claim 1, wherein the system website comprises a group vote mechanism, a group including an odd-number of at least three members being allowed to vote on an opinion on the system website, a group leader being selected from the group, whereby if the group is unanimous, the group leader acts as a representative to vote for the group and provides group member identity for auditing, the asker of the opinion being allowed to set qualifications for group composition, comprising number of members, demographic, age and attributes.

9. The method as claimed in claim 8, wherein the system website comprises an audit mechanism to perform auditing through one of the following three options: represented user claiming a gift in person, represented user using a gift in person, and obtaining an audio frequency of the represented user to re-confirm the representative and the represented are both members and the representation relation exists, the audit mechanism also auditing if other group members or represented user have unanimous opinion, the gift selectively including a present, equivalent points, and coupons, the audio frequency being selectively verified by a real time audio frequency verifier.

10. The method as claimed in claim 1, wherein the system website comprises a surrogate vote mechanism for a member to obtain approval from others to use their identification number so that the member can become a surrogate to represent the others to vote on an opinion.

11. The method as claimed in claim 10, wherein the system website comprises an audit mechanism to perform auditing through one of the following three options: represented user claiming a gift in person, represented user using a gift in person, and obtaining an audio frequency of the represented user to re-confirm the representative and the represented are both members and the representation relation exists, the audit mechanism also auditing if other group members or represented user have unanimous opinion, the gift selectively including a present, equivalent points, and coupons, the audio frequency being selectively verified by a real time audio frequency verifier.

12. The method as claimed in claim 1, wherein the user is allowed to log in the system website through a fixed device or a mobile device.
